(19) United States
(12) Patent Application Publication
(10) Pub. No.: US 2024/0422864 A1
(43) Pub. Date: Dec. 19, 2024

(54) COOKTOP AND METHOD FOR USER ADJUSTABLE PAN TEMPERATURE OFFSET FOR CLOSED LOOP COOKING

(71) Applicant: Haier US Appliance Solutions, Inc., Wilmington, DE (US)

(72) Inventors: Eugenio Gomez, Louisville, KY (US); James Lee Armstrong, Louisville, KY (US); Amelia Lear Hensley, Louisville, KY (US)

(21) Appl. No.: 18/333,608

(22) Filed: Jun. 13, 2023

(51) Int. Cl. H05B 1/02

(52) U.S. Cl. CPC H05B 1/0266

(57) ABSTRACT

A cooktop appliance having a controller in operative communication with an energy control device and a pan surface temperature sensor, the controller configured to receive a pan target temperature input, receive a temperature signal corresponding to the temperature of a surface of the pan, and determine an amount of energy required to maintain a surface of the pan at the pan target temperature.

### FIELD OF THE INVENTION

The present subject matter relates generally to cooktop appliances. More particularly, this disclosure relates to cooktop appliances and methods for controlling heating by the cooktop appliances.

### BACKGROUND OF THE INVENTION

Certain cooktop appliances include one or more heating elements and one or more support surfaces for supporting pots, pans, and other containers with food items therein. The heating elements may use one of a variety of energy sources to produce heat energy. The heating elements can be operated at various energy settings, providing varying amounts of heat energy to the pots, pans, woks, and other containers (collectively “pans” in this document) for heating and cooking food items placed therein. Typical cooktops control the heat energy provided to the pans with control settings ranging from low to high with gradations between.

Some users, and some cooking procedures, require more accurate heating control to produce cooking temperatures in recognized units rather than relative temperatures. Regulating the temperature at the food contact surface in the pan may be difficult as pan size, construction, and thickness impact the heat transfer from the heating element. Thermodynamic characteristics of pans vary widely, resulting in some pans transferring more heat to the food than others. Depending on pan choice, undercooked or overcooked food may result, leading to user dissatisfaction. Current closed-loop heating elements monitor the temperature of the pan bottom and regulate the heating elements to maintain that temperature within a range but lack the ability to predict the temperature at the cooking surface of the pan.

Accordingly, a cooktop appliance with features for accurately regulating temperature at the cooking surface of the pan would be useful.

### BRIEF DESCRIPTION OF THE INVENTION

Aspects and advantages of the invention will be set forth in part in the following description, may be apparent from the description, or may be learned through practice of the invention.

In one exemplary aspect, a cooktop appliance is presented, the cooktop appliance comprising a pan support surface supporting a bottom surface of a pan, the pan comprising an opposite pan top surface. The cooktop appliance further comprises a heating element, an energy control device coupled to the heating element functionally between the heating element and an energy source, a pan surface temperature sensor and a controller in operative communication with the energy control device and the pan surface temperature sensor. The controller comprises a first user input control, the controller is configured to receive a pan target temperature input from the first user input control, receive a signal from the pan surface temperature sensor corresponding to the temperature of a surface of the pan and determine an amount of energy required to maintain a target pan surface temperature such that he pan top surface is maintained at the pan target temperature.

In another example aspect, a method for operating a cooktop appliance comprising a pan support surface supporting a bottom surface of a pan, the pan including an opposite pan top surface, a heating element, and an energy control device coupled to the heating element functionally between the heating element and an energy source, a pan surface temperature sensor, a controller having a first user input control in operative communication with the energy control device and the pan surface temperature sensor is presented. The method comprises receiving, at the controller, a pan target temperature input from the first user input control; receiving, at the controller, a signal from the pan surface temperature sensor corresponding to a temperature of a surface of the pan; determining, at the controller, an amount of energy required to maintain a target pan surface temperature such that the pan top surface is maintained at the pan target temperature; and operating the heating element to provide the determined amount of energy required to maintain the pan surface temperature such that the pan top surface is maintained at the pan target temperature. In another example aspect, method for operating a cooktop appliance is presented. The cooktop appliance comprises a pan support surface supporting a bottom surface of a pan, the pan including an opposite pan top surface, a heating element, and an energy control device coupled to the heating element functionally between the heating element and an energy source. The cooktop appliance further comprises a pan surface temperature sensor, a controller, the having a first user input control, a second user input control, and a third user input control, in operative communication with the energy control device and the pan surface temperature sensor. The method comprising selecting a closed loop cooking mode at the first user control; selecting a pan target temperature at the second user control; setting, by the controller, a target pan surface temperature; measuring continuously, with the pan surface temperature sensor, a temperature of a surface of the pan; and regulating, with the energy control device, the energy supplied to the heating element to maintain the target pan surface temperature, wherein setting the target pan surface temperature includes determining a temperature offset from the target pan surface temperature based on a user selected temperature offset at the third user input control, such that the pan top surface will maintain the pan target temperature.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a top perspective view of a first cooktop appliance in accordance with an embodiment of the present disclosure;

FIG. 2 provides a top perspective view of a second cooktop appliance in accordance with an embodiment of the present disclosure;

FIG. 3 provides a partial sectional view of a pan on the cooktop appliance of FIG. 1;

FIG. 4 provides a partial sectional view of a pan on the cooktop appliance of FIG. 2;

FIG. 5 and FIG. 6 present exemplary illustrations of displays corresponding to a temperature offset in accordance with an embodiment of the present disclosure;

FIG. 7 and FIG. 8 present exemplary illustrations of displays corresponding to a temperature offset in accordance with an embodiment of the present disclosure;

FIG. 9 through FIG. 11 present exemplary illustrations of an initiated closed loop cooking mode in accordance with an embodiment of the present disclosure;

FIG. 12 illustrates a method of operation for a cooktop appliance in accordance with an embodiment of the present disclosure; and

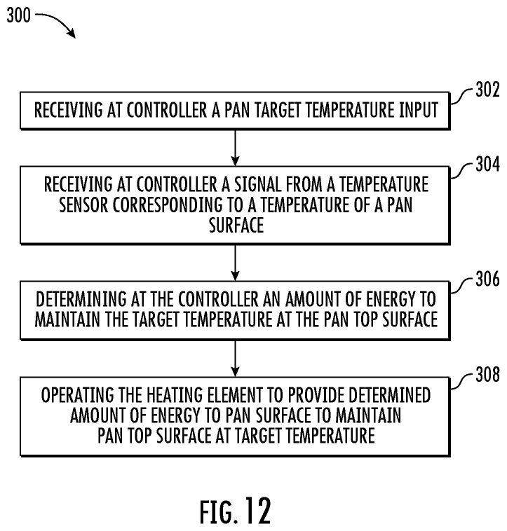

FIG. 13 illustrates a method of operation for a cooktop appliance in accordance with an embodiment of the present disclosure.

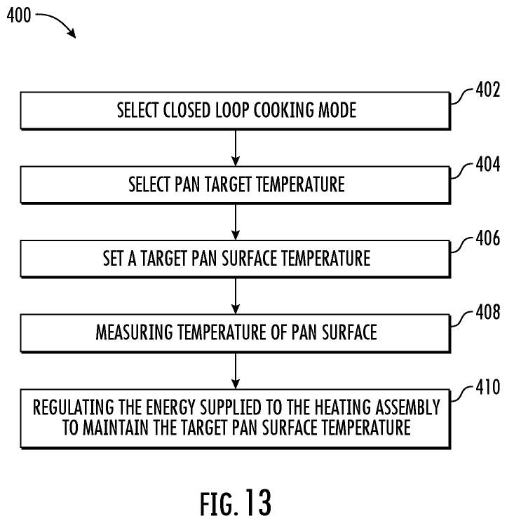

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Embodiments of the present disclosure are directed to a cooktop appliance with a pan support surface supporting a bottom surface of a pan. As used herein, “pan” is intended to cover pots, frying pans, saucepans, skillets, woks, or other vessels or containers typically used to hold food items to be heated or cooked therein. Accordingly, “pan” is not intended to be limiting, but to be inclusive of all suitable containers.

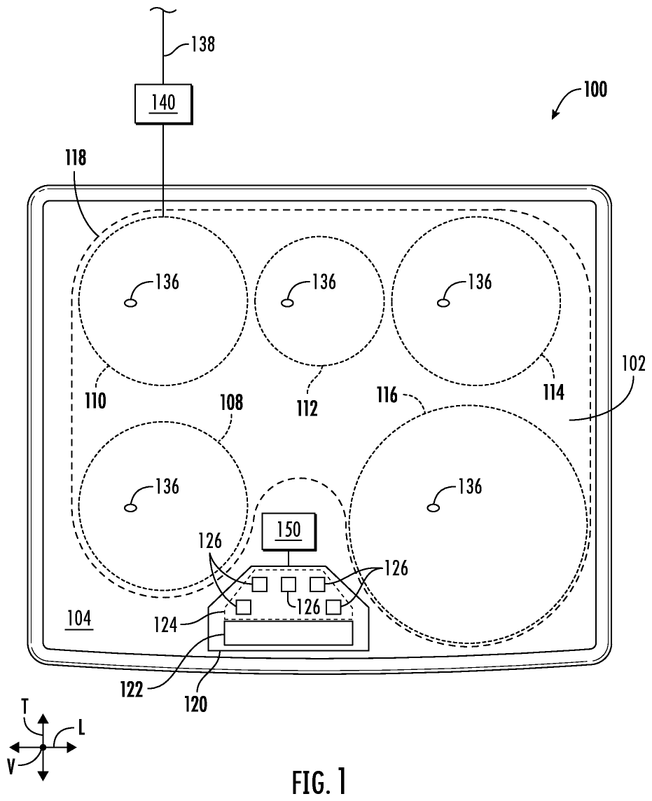

Turning to the figures, FIG. 1 provides a top, plan view of a cooktop appliance 100 in accordance with exemplary embodiments of the present disclosure. Cooktop appliance 100 can be installed in various locations such as in cabinetry in a kitchen, with one or more ovens to form a range appliance, or as a standalone appliance. The cooktop 100 defines a vertical direction V, a lateral direction L, and a transverse direction T, with V, L, and T being mutually perpendicular.

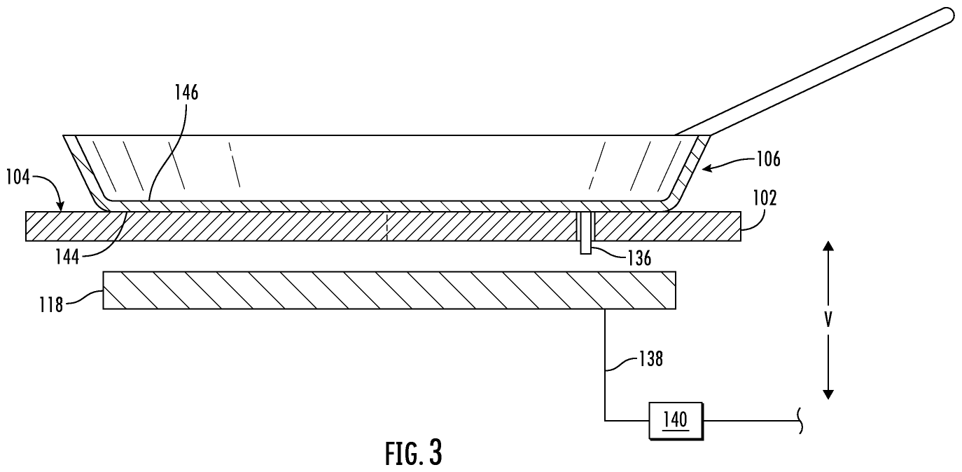

Cooktop appliance 100 includes a cooktop plate 102 for supporting cooking utensils, such as pots or pans, collectively pans, on a cooking or top surface 104 of plate 102. Cooktop plate 102 may alternately be referred to as a pan support surface throughout this disclosure. When assembled, top surface 104 is directed vertically upward to contact a pan, while a bottom interior surface (not shown) is directed vertically downward opposite the top surface 104. Plate 102 may be any suitable rigid plate, such as one formed of ceramic or glass (e.g., glass ceramic). Pan support surface, cooktop plate 102, may alternately be grids, grates, offsets, or other structures or features suitable for supporting a pan 106 (FIG. 3).

One or more heating elements, for example heating elements 108, 110, 112, 114, 116 (collectively heating elements 118 and shown schematically) are mounted vertically below the pan support surface or plate 102 such that heating elements 118 are positioned below top surface 104 (e.g., below the bottom interior surface along the vertical direction V). Plate 102 may be continuous over heating elements 118.

While shown with five heating elements 108, 110, 112, 114, and 116 in the exemplary embodiment of FIG. 1, cooktop appliance 100 may include any number of heating elements 118 in alternative embodiments. Heating elements 118 can also have various diameters. For example, each heating element of heating elements 108, 110, 112. 114, and 116 can have a different diameter, the same diameter, or any suitable combination of diameters. In addition, the heating elements 108, 110, 112, 114, and 116 may include differing numbers or shapes of heating elements. Location of the heating elements 118 in FIG. 1 is for illustration purposes only. Heating elements 118 may be provided in other layouts, distribution, configuration, or orientation in embodiments of this disclosure.

In the illustrative embodiment of FIG. 1, heating elements, collectively heating elements 118, may be electrically powered heating elements, that is, the energy is provided to the heating elements 118 as an electric voltage at a current sufficient to generate a desired thermal output from the heating elements 118. For example, electric power may be provided to cooktop appliance 100, in particular to heating element 110 as illustrated, via electrical conductor 138 which may be electrically connected to a suitable electric source, such as an electric utility supply or generator (not shown). Electrically coupled to the conductor 138 and functionally located between the electric source and the heating element 110 is energy control device 140. Energy control device 140 is in communication with one or more of the user input controls 126 and may selectively control the current flowing to the heating element 110. The selective control of current to the heating element 110 may provide controlled energy output of the heating element 110.

Exemplary heating elements 118 may include one or more radiant heating elements, one or more inductance heating elements, or combinations of radiant and inductance heating elements. Other embodiments may include other types of electrically powered heating elements alone or in combination with those described above.

Pan surface temperature sensors 136 may be located on the cooktop plate 102. generally within the heating elements 118. The pan surface temperature sensors may sense the temperature of a pan surface of interest, for example the bottom surface 144 or the top surface 146 (FIG. 3). Pan surface temperature sensors 136 may be any type of sensor to produce a signal corresponding to a temperature. As used herein, “temperature sensor” or the equivalent is intended to refer to any suitable type of temperature measuring device positioned at any suitable location for measuring the desired temperature. Thus, for example, temperature sensors 136 may each be any suitable type of temperature sensor, such as a thermistor, a thermocouple, a resistance temperature detector, a semiconductor-based integrated circuit temperature sensor, etc. In addition, temperature sensor 136 may be positioned at any suitable location and may output a signal, such as a voltage, to a controller (described below) that is proportional to and/or indicative of the temperature being measured. Although exemplary positioning of temperature sensors is described an illustrated herein, it should be appreciated that appliance 100 may include any other suitable number, type, and position of temperature sensors according to alternative embodiments.

Pan surface temperature sensors 136 may be contact type temperature sensors, in contact with, for example, pan bottom surface 144 as in the illustrative example of FIG. 3. As illustrated, pan surface temperature sensor 136 may extend through cooktop plate 102 to contact pan bottom surface 144. Sensor 136 may be urged vertically upward by a resilient member (not show) to facilitate contact with pan bottom surface 144. In other embodiments, contact with pan bottom surface 144 may be facilitated by placing sensor 136 on the top surface 104 of cooktop plate 102 adjacent to pan bottom surface 144. In other embodiments, other contact type sensors may be used to sense the temperature of other surfaces of the pan 106. In other embodiments, non-contact temperature sensors may be used, for example infrared temperature sensors, may be used to sense the temperature of pan surfaces, for example pan bottom surface 144 or pan top surface 146. The non-contact temperature sensors may be placed in any position to facilitate sensing of the pan surface temperature of interest.

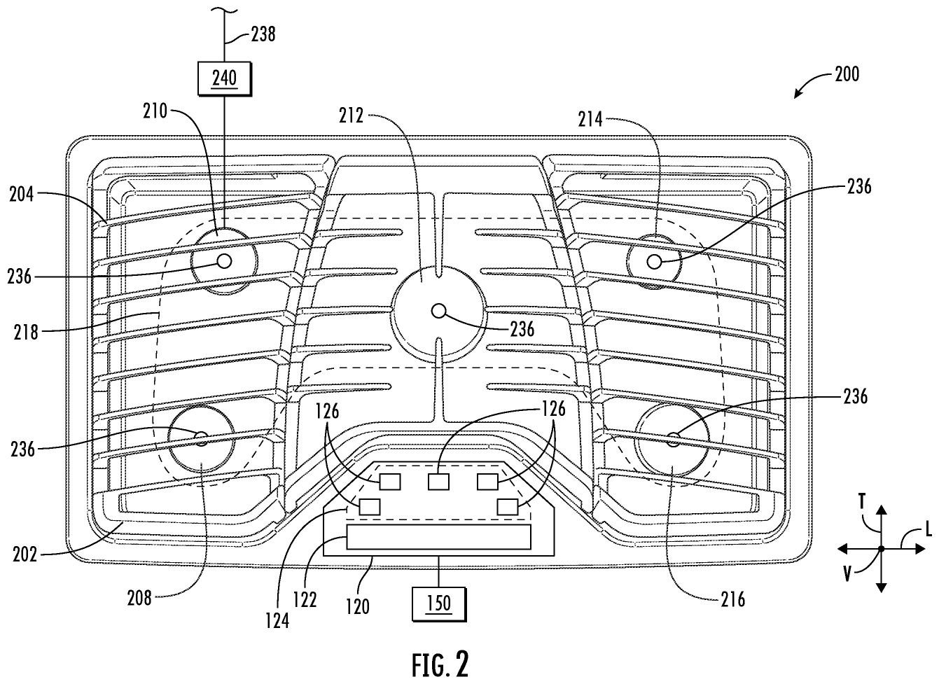

FIG. 2 is illustrative of a cooktop appliance 200 in accordance with an embodiment of the present disclosure, providing a top, plan view of a cooktop appliance 200. Similar to cooktop appliance 100, cooktop appliance 200 can be installed in various locations such as in cabinetry in a kitchen, with one or more ovens to form a range appliance, or as a standalone appliance. The cooktop 200 defines a vertical direction V, a lateral direction L, and a transverse direction T, with V, L, and T being mutually perpendicular.

Cooktop appliance 200 includes a cooktop grate 202 as a series of ribs or bars positioned for supporting cooking utensils, such as pots or pans, collectively pans, on a cooking or top surface 204 of grate 202. Cooktop grate 202 may alternately be referred to as a pan support surface throughout this disclosure. Top surface 204 is directed vertically upward to contact a bottom surface 144 of pan 106. Grate 202 may be formed from any suitable rigid material suitable for use in an environment with temperatures associated with cooking. For example, some cooktop grates 202 may be formed of a suitable metal, such as cast iron. Pan support surface, cooktop grate 202, may alternately have a shape, structures, or features other than those illustrated in FIG. 2 to facilitate the support of a pan 106 (FIG. 3).

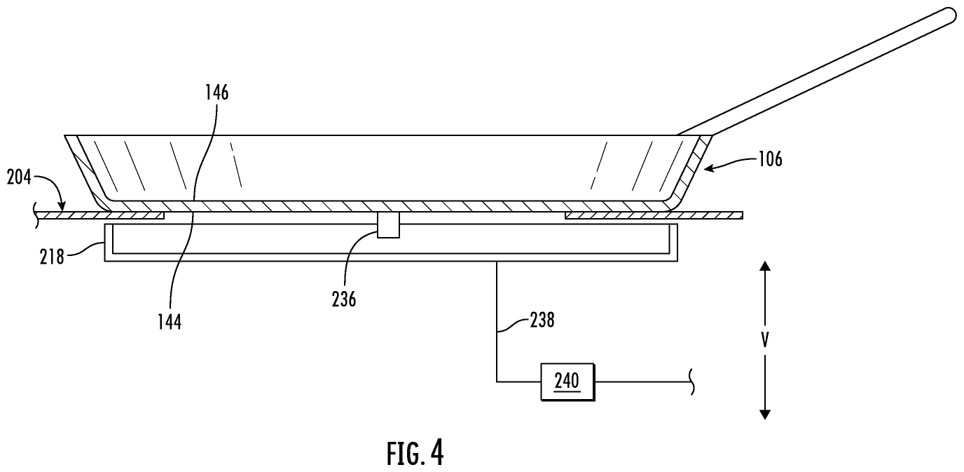

One or more heating elements, for example heating elements 208, 210, 212, 214, 216 (collectively heating elements 218 and shown schematically in FIG. 4) are mounted vertically below the pan support surface or grate 202 such that heating elements 218 are positioned below top surface 204. Grate 202 may be continuous over heating elements 218 as illustrated or each heating element 208-216 may have a separate grate.

While shown with five heating elements 208, 210, 212, 214, and 216 in the exemplary embodiment of FIG. 2, cooktop appliance 200 may include any number of heating elements 218 in alternative embodiments. Heating elements 218 can also have various diameters. For example, each heating element of heating elements 208, 210, 212, 214, and 216 can have a different diameter, the same diameter, or any suitable combination of diameters. In addition, the heating elements 208, 210, 212, 214, and 216 may include differing numbers or shapes of heating elements. Location of the heating elements 218 in FIG. 2 is for illustration purposes only. Heating elements 218 may be provided in other layouts, distribution, configuration, or orientation in embodiments of this disclosure.

In the illustrative embodiment of FIG. 2, collective heating elements 218 may be gas burner heating elements, that is, the energy is provided to the heating elements 218 is a flow of combustible gas at a flow rate sufficient to generate a desired thermal output from the heating elements 218. For example, a suitable fuel, for example natural gas or liquified petroleum may be provided to cooktop appliance 200, in particular to heating element 210 as illustrated, via conduit 238 which may be fluidly coupled to a suitable fuel source, such as an gas utility supply. Fluidly coupled to the conduit 238 and located between the fuel source and the heating element 210 is energy control device 240. Energy control device is in communication with one or more of the user input controls 126 (to be discussed below) and may selectively control the flow of fuel to the heating element 210. The selective control of the flow of fuel to the heating element 210 may provide controlled energy output of the heating element 210.

Pan surface temperature sensors 236 may be located on the cooktop plate 102, generally within the heating elements 118. The pan surface temperature sensors 236 may sense the temperature of a pan surface of interest, for example the bottom surface 144 or the top surface 146 (FIG. 3). Pan surface temperature sensors 236 may be any type of sensor to produce a signal corresponding to a temperature. As discussed above, “temperature sensor” or the equivalent is intended to refer to any suitable type of temperature measuring device positioned at any suitable location for measuring the desired temperature, including thermistors, thermocouples, resistance temperature detectors, semiconductor-based integrated circuit temperature sensors, etc. In addition, temperature sensor 236 may be positioned at any suitable location and may output a signal, such as a voltage, to a controller (described below) that is proportional to and/or indicative of the temperature being measured. Although exemplary positioning of temperature sensors is described and illustrated herein, it should be appreciated that cooktop appliance 200 may include any other suitable number, type, and position of temperature sensors according to alternative embodiments.

Also a s discussed above, pan bottom temperature sensors 236 may be contact type temperature sensors, in contact with pan bottom surface 144 as in the illustrative example of FIG. 4. As illustrated, pan bottom temperature sensor 136 may extend vertically upward from the center of a heating element 218 to contact pan bottom surface 144 and contact with the pad 106 may be maintained as discussed above. In other embodiments, other contact type sensors may be used to sense the temperature of other surfaces of the pan 106. In other embodiments, non-contact temperature sensors may be used, for example infrared temperature sensors, may be used to sense the temperature of a pan surface, for example pan bottom surface 144 or pan top surface 146. The non-contact temperature sensors may be placed in any position to facilitate sensing of the pan surface temperature of interest.

FIGS. 1 and 2 are representative of types of cooktop appliances 100, 200, respectively, in accordance with the present disclosure. Thus, as used herein, the term “cooktop appliance” includes gas and electric grill appliances, stove appliances, range appliances, and other appliances that incorporate cooktops. Nonetheless, cooktop appliances 100 and 200 are provided by way of example only for description, not limitation. Embodiments of the present disclosure are not limited to the exemplary embodiments illustrated in FIGS. 1 and 2.

Cooktop appliance 100 and 200 operate under the same, or substantially the same, control system. Each cooktop appliance 100, 200 includes a user interface 120, a display panel 122, a control panel 124, and user input controls 126. The following discussion generally relates to the control of the heating elements 118, 218 of both cooktop appliances 100 and 200.

User interface 120 may include a control portion, control panel 124 including user input controls 126, for example one user input control for each heating element 108-116. The user input controls 126 may accept and respond to a user's commands to control various aspects of the cooktop appliances 100, 200. Input devices 126 may include one or more push buttons, rotating dials, or touch screens, or combinations thereof, suitable to enter instructions for the operation of aspects of the cooktop appliance 100. User interface 120 can be any type of input device and can have any configuration. In FIGS. 1 and 2, user interface 120 is located within a portion of the cooktop appliances 100, 200 in the T-L plane (i.e., generally horizontal). Alternatively, user interface 120 can be positioned at another location that is convenient for a user to access during operation of cooktop appliances 100, 200.

User interface 120 may include a display panel 122 to display visual information to a user regarding the operation of cooktop appliances 100 and 200. For example, a display panel 122 can include a graphical representation of each of the heating elements 118, 218, a selected cooking temperature, status, or other options. According to embodiments of the present disclosure, a user may use the user input controls to select a closed loop cooking mode in which the cooktop appliance 100. 200 operates to maintain a predetermined temperature at the pan top surface 146. An indication that the closed loop cooking mode is enacted may be displayed on the display panel 122.

Cooktop appliances 100, 200 include a controller 150 in operative communication with the user interface 120. Operation of cooktop appliances 100, 200 is regulated by controller 150. Accordingly, controller 150 is operatively coupled or in communication with the various components of cooktop appliances 100, 200 including heating elements 118, 218, temperature sensors 136, 236, and energy control devices 140, 240. In response to user manipulation of the user interface 120, controller 150 operates the various components of cooktop appliance 100 to execute selected cycles and features.

Controller 150 may include memory (e.g., non-transitory media) and microprocessor, such as a general or special purpose microprocessor operable to execute programming instructions or micro-control code associated with an operation of the cooktop appliances 100, 200. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 150 may be constructed without using a microprocessor (e.g., using a combination of discrete analog or digital logic circuitry, such as switches, amplifiers, integrators, comparators, flip-flops, AND gates, and the like) to perform control functionality instead of relying upon software. Heating elements 118, 218, user interface 120, and other components of cooktop appliances 100, 200 may be in communication with controller 150 via one or more signal lines or shared communication busses.

In accordance with the present disclosure, one or more heating elements 118, 218 of cooktop appliances 100, 200 may operate in a user selectable closed loop cooking mode. The closed loop cooking mode may not be a default cooking mode for the heating elements 118, 218 of cooktops 100, 200. Accordingly, a user may manipulate one or more user input controls 126 to call up or activate the closed loop cooking mode. In embodiments, the display panel 122 may indicate the closed loop cooking mode activated for one or more heating elements 118, 218 upon selection of the mode by the user.

In the closed loop cooking mode, the user may select a desired cooking temperature from a user input control 126. The selected temperature may be measured in degrees Fahrenheit or degrees Celsius and displayed as a numerical value on display 122. The user input control 126 sends a signal through the control panel 124 to the controller 150 indicating the closed loop mode is activated and the pan target temperature. In the closed loop mode, the controller 150 compares the pan target temperature to the temperature of a pan surface, for example bottom surface 144, as determined from the signal sent by temperature sensor 136 to controller 150. Accordingly, a pan 106 must be present on the heating element 118 for the closed loop cooking method to operate.

In some embodiments, the closed loop cooking mode may be used with input controls with other measures of heating power. For example, a user input control 126 may allow a user to enter temperatures specified as low-medium-high or on a scale of 1-10 without an indication of the exact target temperature communicated to the user. In the closed loop mode, the controller 150 would still compare the actual temperature of the pan surface with the user selected pan target temperature. However, the pan target temperature would be user set for a selection between low and high (or 1 and 10) with the actual temperature value predetermined and generally unknown to the user.

In embodiments, upon initiation of the closed loop mode, the controller signals the energy control device 140, 240 to open, starting the flow of energy to the specified heating element. In cooktop appliance 100, the open energy control device 140 allows electrical energy to flow to the heating element (e.g., heating element 118) energizing the element 118 for the production of heat. In cooktop appliance 200, the controller 150 signals the energy control device to open allowing the flow of combustible gas to a heating element (e.g., heating element 218). Generally, simultaneously with the start of the flow of combustible gas, controller 150 signals the heating element 218 to ignite the gas, for example with an electric spark. The ignition of the gas and the maintained combustion of the gas generates heat.

In both cooktop appliances 100 and 200, the generated heat is directed to the pan bottom surface 144 which increases the temperature of pan bottom surface 144. Through heat transfer, for example conduction, the heat directed to the bottom surface 144 transfers to the rest of the pan surfaces, for example sides and top surface 146. Temperature sensor 136 is continuously monitoring the temperature of the pan surface of interest, for example bottom surface 144, and sending the information to the controller 150. If, after a predetermined period of time, temperature sensor 136 fails to detect a temperature change in the pan surface temperature, controller determines pan 106 is not present and signals energy control device 140, 240 to close, stopping the energy flow to the heating element.

In other embodiments, when the closed loop mode is initiated, the pan target temperature is input at a user input control 126 and received at the controller 150. The pan 106 is in place on pan support surface (i.e., plate 202 (FIG. 1) or grate 202 (FIG. 2)), the heating elements 118, 218 receive an energy flow and ignition, if needed, and begin heating the pan bottom surface 144 as discussed above. Through heat transfer, for example conduction, the energy, as heat, added to the bottom surface 144 of pan 106 flows throughout the pan 106. Temperature sensor 136, 236 continuously monitors the temperature of the pan s surface of interest and communicates a signal corresponding to the temperature to the controller 150. The controller 150 receives the signal from the pan surface temperature sensor 136, 236 and compares it to the pan target temperature. An algorithm stored at the controller 150 executes programming instructions associated with a heating operation of the cooktop appliances 100, 200 comparing the sensed pan surface temperature to the target temperature. The algorithm further determines the amount of energy required to raise the temperature of the pan surface being measured to a temperature such that the a pan surface temperature, for example pan top surface 146, will maintain the target temperature.

The algorithm at the controller 150 may be empirically derived from a sampling of commercially available pans cycled through the closed loop cooking mode and stored to a memory location of the controller 150 at the factory. This may represent an algorithm developed through repetition and experimentation that approximates a reasonable pan performance. The algorithm may mathematically predict the temperature of the pan surface (for example, a target pan bottom temperature) required to maintain the pan top surface 146 within an predetermined range of the target temperature. The controller 150 adjusts the energy control device 140, 240 to maintain the temperature of the pan surface to within a range of temperature to maintain the pan top surface 146 within the range. Controlling the energy control device 140, 240 may include adjusting the flow rate of energy to the heating elements 118, 218, or may require cycling the heating elements 118, 218 on and off. The energy control device 140, 240 may also direct more energy to portions of a heating element than to others to achieve the target temperature at the pan top surface 146.

The algorithm may establish a predetermined temperature offset that is applied to all instances of the closed loop cooking mode. In other embodiments, the algorithm may compare the sensed and target temperatures and apply an offset to the temperature of the pan surface necessary to reach the target temperature at the pan top surface 146. The temperature offset may be a fixed temperature differential between the target temperature and the temperature of the pan surface measured. For example, regardless of the target temperature, the target temperature of the pan surface may need to be a constant temperature offset, either above or below the target temperature, in order to maintain the target temperature at the pan top surface 146. In other embodiments, the temperature offset may vary with the target temperature. In still other embodiments, the temperature offset determined by the algorithm may be a multiplier of the target temperature. In some embodiments, the temperature offset may depend on the temperature difference between the target temperature and the pan surface temperature being measured (for example the temperature of the pan bottom surface 144).

In some embodiments, once the closed loop mode is initiated, a user may linearly adjust the temperature offset between the target temperature and the target temperature of the pan surface being measured. The user may be using a pan 106 with thermal characteristics incompatible with the algorithm, leading to unsatisfactory results when relying solely on the algorithm. In other cases, the cooktop appliance 100 may be operating in an environment that affects the accuracy of the algorithm. In still other cases, inaccuracies may exist in the closed loop features of the cooktop 100, 200, negatively affecting the accuracy of the algorithm. For a cooking event, or instance, using the incompatible pan or having other negative factors affecting the algorithm, the user may initiate the closed loop cooking mode and, through manipulation of user input controls 126, may activate a feature that allows a linear adjustment to the offset determined by the algorithm. Without changing the target temperature, the user may manually adjust the offset temperature, thus changing the target temperature of the pan surface being measured (for example pan bottom surface 144). For example, if the user knows or believes that the temperature of the pan top surface 146 is 20 degrees below the target for cooking events using a particular pan, the user can change the temperature offset to increase the temperature of the top surface of the pan by 20 degrees. User-created offsets may be linear in nature (i.e., a constant offset). In embodiments with a non-linear offset determined by the algorithm and modified by a linear user-created offset, the net effect will be a non-linear offset.

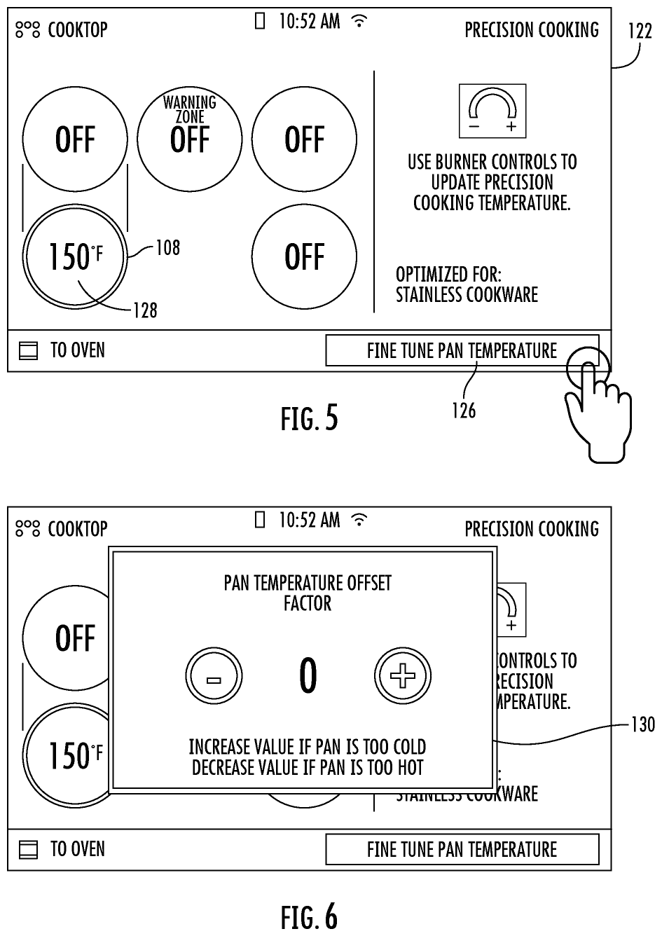

In one embodiment, the manually adjusted temperature offset for the target temperature of the pan surface resets to zero at the end of the cooking event. That is, once the heating element is turned off, the manual adjustment to the temperature offset is lost. FIGS. 5-6 present exemplary illustrations of displays corresponding to this embodiment. When the closed loop cooking mode is activated, a screen similar to FIG. 5 may appear in the display panel 122. The display panel 122 may indicate the heating element 108 selected for closed loop control and the target temperature of the pan surface 128. Manipulation of a user input control 126, for example, as illustrated, a “Fine Tune Pan Temperature” control, initiates a manually adjusted temperature screen 130 as illustrated in FIG. 6. The temperature screen 130 may provide instructions for adjusting the temperature offset used for the present cooking event. As illustrated, the control may include a selectable pan temperature offset factor, which may correspond to a temperature variance. As illustrated the factor may be zero as a default and selectable, either greater than zero or less than zero depending on the desired user control. A factor greater than zero may be selected to make the target temperature of the pan surface higher than a predetermined offset, if any. A factor less than zero may be chosen to make the target temperature of the pan surface lower. The indicated target temperature for the pan surface 128 remains unchanged. At the end of the cooking event, the manual offset factor returns to zero.

In other embodiments, the user is given an opportunity and directions, for example through text or images on the display panel 122, to save the offset temperature. If the user believes the offset generated by the algorithm is incorrect in general (i.e., is incorrect in the same manner for each pan used), the user may save the adjusted temperature offset to a global setting such that all heating elements will be affected by the offset in the same way for each cooking event, i.e., each time the closed loop cooking mode is called.

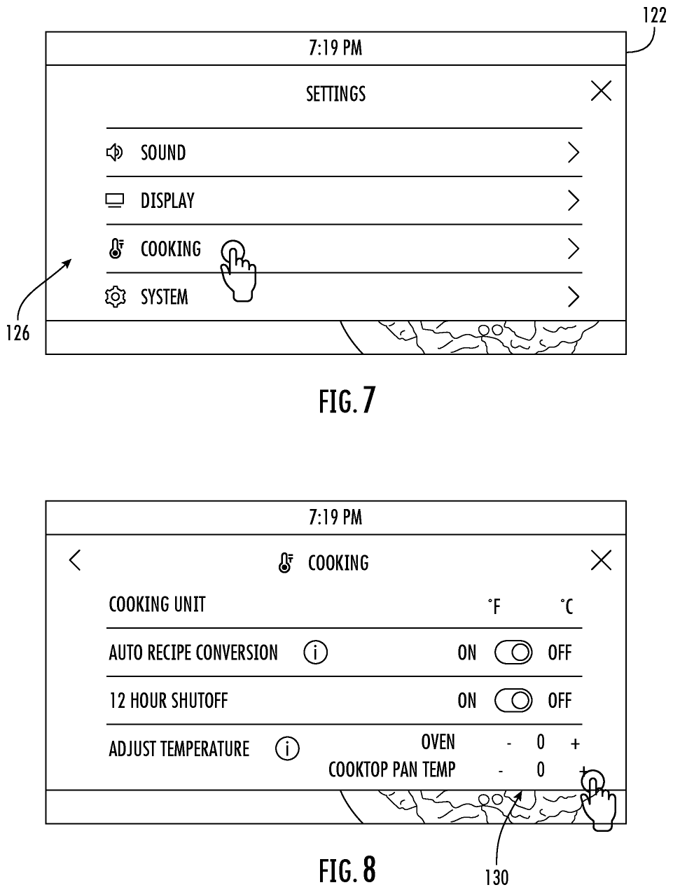

For example, in the illustrative embodiment of FIG. 7, a general settings menu is presented on screen 122 User manipulation of the controls 126, for example selecting “cooking” from the general menu of FIG. 7, may produce a screen as shown in FIG. 8. The closed loop mode may include a “Cooking Pan Temp” function screen 130 allowing user-created global offset setting for all heating elements 118. As above, a screen 130 may provide a user-selectable pan temperature offset factor, in this case, the factor may be applied to all heating elements 118 of the cooktop appliance 100. The user may be provided with the option to save the global offset, for example to controller 150. The saved offset may be the default offset for all heating elements 118 for future cooking events unless, or until, a user resets the offset. Any manual offsets as described above may be in addition to a save global offset.

Alternately, the adjusted temperature offset may be stored as a named or identified offset. For example, if the user is pleased with a manually adjusted temperature offset, for example in use with a particular pan, the user-created offset may be saved under a name or identification selected by the user. At the conclusion of the present cooking event, the user-created offset is saved to a memory location in the controller 150. At a subsequent cooking event or events, the user may recall the user-created offset for use. The user-created offset may then be used by the controller to make necessary adjustments in order to control the pan temperature to correspond with the target pan surface temperature. This may be repeated for a plurality of user-created offsets for different individual pans. Each of the plurality of user-created temperature offsets may be separately named or identified and saved to a memory location in the controller 150. At subsequent cooking events, the desired user-created offset may be selected from the plurality.

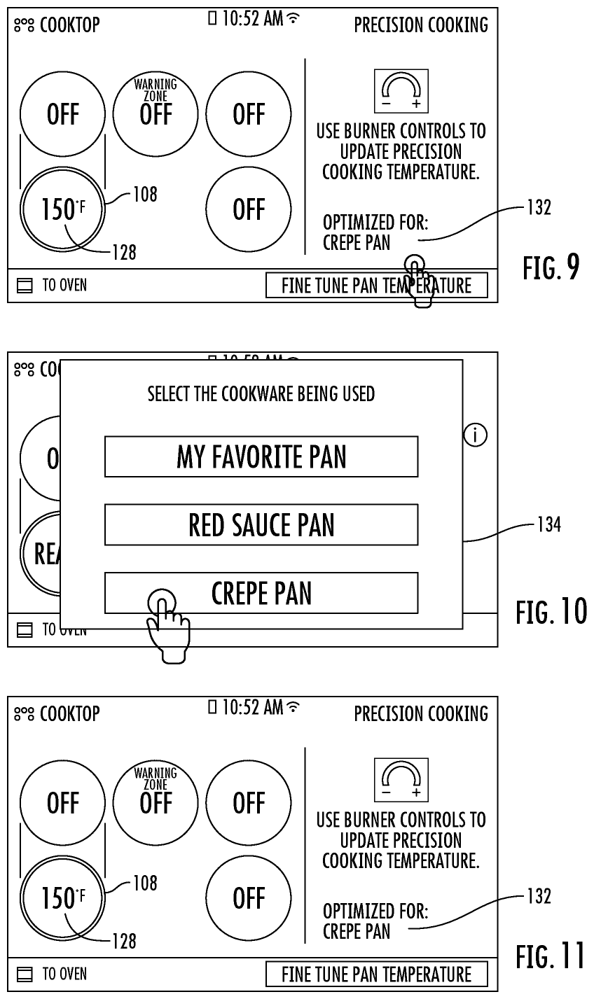

For example, FIGS. 9-11 are illustrative of an initiated closed loop cooking mode as displayed at display 122. In some embodiments, an optimization input window 132 may be displayed in the user interface 120, for example in the display 122. The heating element 108 selected for the closed loop mode of cooking and pan target temperature 128 may be indicated in the display 122. Previously stored optimized temperature offsets may be recalled, displayed, and selected by manipulating a user input control 126. As illustrated in FIG. 10, manipulation of optimization window 132 may produce selection screen 134 providing a list of named selectable preset temperature offsets (three shown). The selectable presents may be user-created presets that correspond to particular cooking pans. Confirmation of the selected pan may be provided by indicating the selected preset in the optimization window 132 as illustrated in FIG. 11. The user-created offset may return to zero at the end of the cooking event.

The user-created temperature offsets may operate instead of, or in addition to, any offset or offsets determined by the algorithm. For example, a user-created offset may linearly offset the target temperature with no input from the algorithm. Each time that user-created temperature offset is called, the target temperature is offset, in the same direction (either hotter or cooler), and the controller 150 adjusts the heating elements 118, 218 to produce that temperature at the pan surface being measured (for example pan bottom surface 144).

Alternately, a user-created temperature offset may be an offset applied to the offset determined by the algorithm. If a user-created temperature offset is used to modify a linear offset determined by the algorithm, the net effect will be a linear offset. Similarly, if a user-created temperature offset is used to modify a non-linear offset as determined by the algorithm, the resulting offset will be non-linear.

Now that the construction of a cooktop appliance in accordance with this disclosure has been presented, an exemplary method 300 of operation for user adjustable pan temperature offset for closed loop cooking will be described with reference to FIG. 5. Method 300 begins at 302 with receiving at the controller 150 a pan target temperature input. The input may come from a user input control 126. The input may be a target temperature expressed in degrees selected by a user at the control panel 124. Prior to or simultaneously with selecting the target temperature, the cooktop appliance may be placed in closed loop cooking mode, which may be activated when the target temperature is selected.

At 304, a temperature signal is received at the controller, the signal corresponding to the temperature of the surface of a pan 106 supported on a pan support surface 102, 202. The sensor continuously senses or measures the temperature of the pan surface of the pan 106 and sends a signal corresponding to the temperature back to the controller 150. The pan surface under measurement may be any surface of the pan 106 (i.e., bottom surface 144, top surface 146, or side surface).

At 306, the controller determines an amount of energy to be added to the pan bottom surface 144 in order to raise the pan surface temperature to a temperature sufficient to maintain the pan top surface 146 at the target temperature. The controller 150 includes a processor programmed with steps to execute an algorithm to determine the target pan surface temperature and the energy needed to reach and maintain that temperature. The algorithm may use thermodynamic characteristics of a theoretical representative pan in determining the energy requirements. Various thermal characteristics of the pan affect the energy requirements to maintain a target pan surface temperature. The target pan surface temperature may be offset from the target temperature by a fixed amount, a multiplier of the target temperature, a multiplier of the temperature difference, or other thermodynamic factors. The algorithm relieves the user from having to consider these factors when turning on a cooktop appliance. The algorithm selects a predetermined formula for determining an offset of the target temperature to set a target pan surface temperature and provides the controller with instructions for maintaining that temperature.

At 308, the controller 150 operates the heating elements 118, 218, following the instructions from the algorithm, to reach and maintain the target pan surface temperature such that the pan top surface temperature is at the target temperature, or within a predetermined range of the target temperature.

Another exemplary method 400 of operation for user adjustable pan temperature offset for closed loop cooking will be described with reference to FIG. 6. Method 400 begins at 402 which includes selecting a closed loop cooking mode at a user input control. This may be achieved through manipulation of one or more user input controls 126 at user interface 120.

At 404, once the closed loop cooking mode is selected, a pan target temperature is selected at another user input control. The pan target temperature is the temperature of the top surface 146 of the pan 106. As the food heated or cooked in the pan 106 rests at least partially on the pan top surface, the target pan temperature is the temperature at the intersection of the food and the pan.

At 406, a target pan bottom temperature is set by the controller 150. A processor at controller 150 includes a series of instructions that, when executed, determines the target pan surface temperature that will result in the pan top surface attaining and maintaining the target temperature. The processor 150 executes the instructions, a mathematical algorithm that determines a theoretical target pan surface temperature that will yield the target temperature at the top surface. The steps may represent an empirical mathematical expression representing testing and experimentation on a selection of pans to determine a generalized expression for selecting a target pan bottom temperature that will, within a prescribed range, maintain the target temperature at the pan top surface 146. Step 406 may include determining a temperature offset from the target pan surface temperature based on one of a predefined correlation algorithm and a user selected temperature offset at the third user input control, such that the pan top surface will maintain the pan target temperature.

At 408, the temperature sensor 136, 236 continuously senses pan surface temperature, sending the resulting signal corresponding to the temperature sensed to the controller 150. A processor at the controller 150 receives the signal and determines the actual temperature of the pan surface being measured. This is a continuous process with temperature signals constantly being communicated back to controller.

At 410, a processor at the controller compares the actual pan surface temperature from 408 with the target pan temperature of 406. The difference between the actual and the target is determined at the processor and the controller regulates the energy supplied to the heating element to maintain the target pan surface temperature.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A cooktop appliance defining a vertical direction, a lateral direction, and a transverse direction, each of which is mutually perpendicular, the cooktop appliance comprising:
a pan support surface supporting a bottom surface of a pan, the pan comprising an opposite pan top surface;
a heating element;
an energy control device coupled to the heating element functionally between the heating element and an energy source;
a pan surface temperature sensor; and
a controller in operative communication with the energy control device and the pan surface temperature sensor, the controller comprising a first user input control, wherein the controller is configured to:
receive a pan target temperature input from the first user input control;
receive a signal from the pan surface temperature sensor corresponding to the temperature of a surface of the pan; and
determine an amount of energy required to maintain a target pan surface temperature such that the pan top surface is maintained at the pan target temperature.

2. The cooktop appliance of claim 1, wherein the heating element is disposed vertically below the pan support surface.

3. The cooktop appliance of claim 1, wherein the target pan surface temperature is offset from the pan target temperature.

4. The cooktop appliance of claim 3, wherein the offset is a predetermined temperature offset.

5. The cooktop appliance of claim 1, wherein the controller comprises a second user input control, further wherein the controller receives a user selectable temperature offset from the second user input control.

6. The cooktop appliance of claim 5, wherein the target pan bottom temperature is linearly offset from the pan target temperature by the user selectable temperature offset.

7. The cooktop appliance of claim 5, wherein the user selectable temperature offset is set to zero at a conclusion of a cooking event.

8. The cooktop appliance of claim 5, wherein the user selectable temperature offset is saved to the controller as a user named temperature offset.

9. The cooktop appliance of claim 8, wherein the user named temperature offset is recalled by the controller at a subsequent cooking event and the target pan surface temperature is offset by the user named temperature offset.

10. The cooktop appliance of claim 8, wherein the user named temperature offset is selectable by a user at a subsequent cooking event and the target pan surface temperature is offset by the user named temperature offset selected.

11. The cooktop appliance of claim 10, wherein the user named temperature offset is selectable from a plurality of user named temperature offsets.

12. The cooktop appliance of claim 1, wherein the energy source is one of natural gas, liquified petroleum, or electricity.

13. A method for operating a cooktop appliance comprising a pan support surface supporting a bottom surface of a pan, the pan including an opposite pan top surface, a heating element, and an energy control device coupled to the heating element functionally between the heating element and an energy source, a pan surface temperature sensor, a controller in operative communication with the energy control device and the pan surface temperature sensor, the controller comprising a first user input control,
wherein the method comprises:
receiving, at the controller, a pan target temperature input from the first user input control;
receiving, at the controller, a signal from the pan surface temperature sensor corresponding to a temperature of a surface of the pan;
determining, at the controller, an amount of energy required to maintain a target pan surface temperature such that the pan top surface is maintained at the pan target temperature; and
operating the heating element to provide the determined amount of energy required to maintain the pan surface temperature such that the pan top surface is maintained at the pan target temperature.

14. The method of claim 13, wherein determining, at the controller, an amount of energy, includes offsetting the target pan surface temperature from the pan target temperature.

15. The method of claim 14, wherein the target pan bottom temperature is offset by a user selectable temperature offset.

16. The method of claim 15, wherein the user selectable temperature offset is set to zero at a conclusion of a cooking event.

17. The method of claim 15, wherein the user selectable temperature offset is saved to the controller as a user named temperature offset.

18. The method of claim 17, wherein the user named temperature offset is recalled by the controller at the next cooking event and the target pan surface temperature is offset by the user named temperature offset.

19. The method of claim 17, wherein, at a subsequent cooking event, the user named temperature offset is selectable by a user from a plurality of user named temperature offsets saved at the controller and the target pan surface temperature is offset by the user named temperature offset selected.

20. A method for operating a cooktop appliance comprising a pan support surface supporting a bottom surface of a pan, the pan including an opposite pan top surface, a heating element, and an energy control device coupled to the heating element functionally between the heating element and an energy source, a pan surface temperature sensor, a controller in operative communication with the energy control device and the pan surface temperature sensor, the controller comprising a first user input control, a second user input control, and a third user input control, wherein the method comprises:
selecting a closed loop cooking mode at the first user control;
selecting a pan target temperature at the second user control;
setting, by the controller, a target pan surface temperature;
measuring continuously, with the pan surface temperature sensor, a temperature of a surface of the pan; and
regulating, with the energy control device, the energy supplied to the heating element to maintain the target pan surface temperature; and
wherein setting the target pan surface temperature includes determining a temperature offset from the target pan surface temperature based on a user selected temperature offset at the third user input control, such that the pan top surface will maintain the pan target temperature.
